(19) United States
(12) Patent Application Publication
(10) Pub. No.: US 2023/0368757 A1
(43) Pub. Date: Nov. 16, 2023

(54) GENERATION DEVICE

(71) Applicant: YAMAHA CORPORATION, Hamamatsu-shi (JP)

(72) Inventors: Keisuke ITO, Tokyo (JP); Jun USUI, Hamamatsu-shi (JP); James Gerard BUELL, JR., Tokyo (JP); Christopher John PEARCE, Tokyo (JP); Daisuke YUKITA, Chigasaki-shi (JP); Kaoru TANAKA, Tokyo (JP); Alex STAUDT, Brooklyn, NY (US)

(21) Appl. No.: 18/314,273

(22) Filed: May 9, 2023

(30) Foreign Application Priority Data
May 10, 2022 (JP) 2022-077635

(51) Int. Cl. G10H 1/00; G10H 7/00

(52) U.S. Cl. CPC G10H 1/0008; G10H 1/0091; G10H 7/002; G10H 2210/341; G10H 2220/005

(57) ABSTRACT

The present disclosure provides a generation device having a plurality of operators that receive a user operation that causes generation of a sound. The generation device includes: at least one first operator arranged in a first region and configured to receive a first user operation that causes generation of a rhythm sound signal; at least one second operator arranged in a second region and configured to receive a second user operation that causes generation of a melody sound signal; and at least one third operator arranged in a third region and configured to receive a third user operation that causes a sound effect to be applied to a synthesized sound signal of the generated rhythm sound signal and the generated melody sound signal. The first region, the second region, and the third region are different regions of the generation device from each other.

### CROSS-REFERENCE TO RELATED APPLICATIONS

This application is based on and claims priority under 35 USC 119 from Japanese Patent Application No. 2022-077635 filed on May 10, 2022, the contents of which are incorporated herein by reference.

### TECHNICAL FIELD

The present disclosure relates to a generation device.

### BACKGROUND ART

In the related art, there has been known a generation device including an operator for inputting a sound signal such as a rhythm sound or a melody sound. For example, “Novation”, [online], CIRCUIT TRACKS (searched on Mar. 28, 2022), Internet <URL: https://novationmusic.com/en/circuit/circuit-tracks>, and “Teenage Engineering”, [online], OP-Z, (searched on Mar. 28, 2022), Internet <URL: https://teenage.engineering/products/op-z> disclose a generation device that selects functions to be assigned to a plurality of operation buttons, respectively, arranged side by side using a predetermined button and implements the functions by operating the respective plurality of operation buttons. Functions implemented by the plurality of operation buttons include, for example, setting of a musical instrument sound (tone), setting of a sound generation pattern of a rhythm sound, input of a melody sound (performance, input operation, and the like), setting of a sound effect, and the like.

### SUMMARY OF INVENTION

However, since the functions applied to the plurality of operation buttons are switched, the same operation button is shared by a plurality of different functions. Therefore, it is not easy to intuitively perform an operation for generating a sound.

An object of the present disclosure is to provide a generation device capable of generating a sound by an intuitive operation.

The present disclosure provides a generation device having a plurality of operators that receive a user operation that causes generation of a sound, the generation device including: at least one first operator arranged in a first region of the generation device, the at least one first operator being configured to receive a first user operation that causes generation of a rhythm sound signal; at least one second operator arranged in a second region of the generation device, the at least one second operator being configured to receive a second user operation that causes generation of a melody sound signal; and at least one third operator arranged in a third region of the generation device, the at least one third operator being configured to receive a third user operation that causes a sound effect to be applied to a synthesized sound signal, the synthesized sound signal being a synthesized sound signal of the generated rhythm sound signal and the generated melody sound signal, wherein the first region of the generation device, the second region of the generation device, and the third region of the generation device are different regions of the generation device from each other.

According to an aspect of the present disclosure, a sound can be generated by an intuitive operation.

### BRIEF DESCRIPTION OF DRAWINGS

The present disclosure will be described in detail based on the following figures, wherein:

FIG. 1 is a top view of a generation device; and

FIG. 2 is a functional block diagram of the generation device.

### DESCRIPTION OF EMBODIMENTS

Hereinafter, an embodiment of the present disclosure will be described with reference to the drawings.

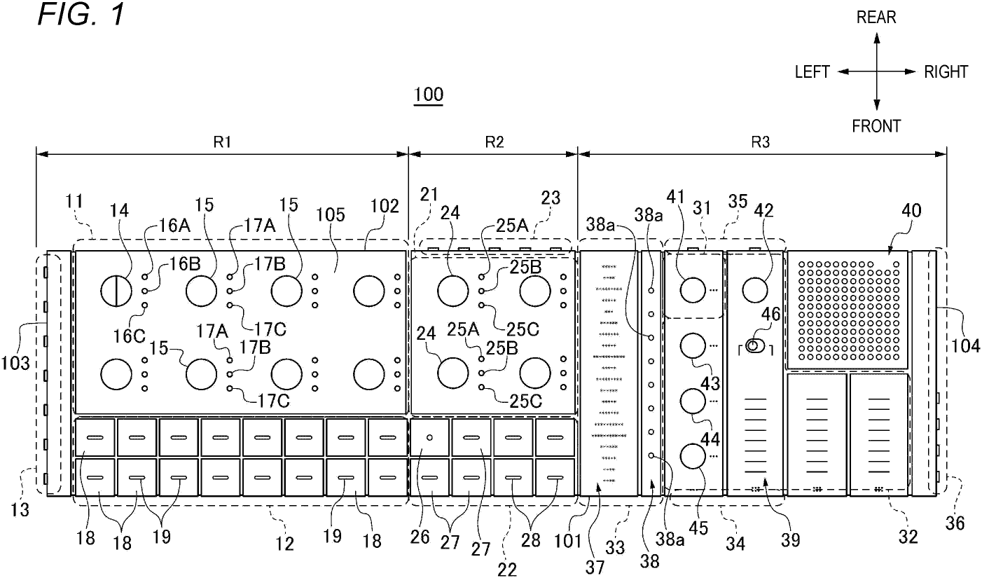

FIG. 1 is a top view of a generation device according to an embodiment of the present disclosure. A generation device 100 is, for example, a device that generates a sound signal in accordance with an input operation. An external appearance of the generation device 100 is a rectangular parallelepiped. The generation device 100 includes a front surface 101, a back surface 102, a left side surface 103, a right side surface 104, and an upper surface 105 (an example of a main operation surface) in addition to a bottom surface (not shown). Regarding directions of the generation device 100, a side (near side) on which a user is positioned is referred to as a front side, and a left-right direction is referred to directions viewed from the user.

The generation device 100 includes a plurality of operators. Each of the front surface 101, the back surface 102, the left side surface 103, the right side surface 104, and the upper surface 105 is an operation surface on which at least one operator is arranged. There may be an operation surface on which an operator is not arranged. Arrangement regions of the operators in the generation device 100 are roughly divided into a first region R1, a second region R2, and a third region R3. The first region R1, the second region R2, and the third region R3 are aligned in this order from the left. The first region R1 and the second region R2 are adjacent to each other, and the second region R2 and the third region R3 are adjacent to each other. The first region R1 and the second region R2 may be immediately adjacent regions of the generation device 100 to each other, and the second region R2 and the third region R3 may be immediately adjacent regions of the generation device 100 to each other.

In the first region R1, operators that receive an operation for generating a rhythm sound signal are arranged. In the second region R2, operators that receive an operation for generating a melody sound signal are arranged. In the third region R3, operators that receives an operation for applying a sound effect to a synthesized sound signal obtained by synthesizing a rhythm sound signal and a melody sound signal are arranged.

The first region R1 includes a first upper surface region 11, a second upper surface region 12, and a first side surface region 13. The second region R2 includes a third upper surface region 21, a fourth upper surface region 22, and a second side surface region 23. The third region R3 includes a fifth upper surface region 31, a sixth upper surface region 32, a seventh upper surface region 33, a third side surface region 34, a fourth side surface region 35, and a fifth side surface region 36.

In the first upper surface region 11 of the first region R1, one operator 14 and a plurality of (for example, seven) operators 15 are arranged. In the second upper surface region 12, a plurality of (for example, sixteen) operators 18 are arranged. The operators 14 and 15 are first setting operators that receive at least an operation for setting a sound generation pattern. The operators 18 are first input operators that receive at least an operation for inputting a sound generation timing. Each of the operators 18 includes a light emitting part 19 as a notification part from which a notification indicating information corresponding to a sound generation timing of a rhythm sound signal is output. The light emitting part 19 is provided at a visible position on an upper portion of the operator 18. The light emitting part 19 is, for example, a light transmitting part that transmits light from an LED disposed below. Push button type operators are disposed in the first side surface region 13.

In the third upper surface region 21 of the second region R2, a plurality of (for example, four) operators 24 are arranged. In the fourth upper surface region 22, one operation element 26 and a plurality of (for example, seven) operators 27 are arranged. The operators 24 are second setting operators that receive at least an operation for setting a musical instrument sound. The operators 27 are second input operators that receive at least an operation for inputting a pitch. Each of the operators 27 includes a light emitting part 28 similar to the light emitting part 19 as a notification part from which a notification indicating information corresponding to a sound generation timing of a melody sound signal is output. Push button type operators are disposed in the second side surface region 23.

In the fifth upper surface region 31 of the third region R3, an operator 41 is disposed. The operator 41 is a third setting operator that receives at least an operation for setting a sound parameter. In the sixth upper surface region 32, operators 42, 43, 44, 45, and 46 are arranged. The operators 42 to 46 are fourth setting operators that receive at least an operation for setting a sound effect. Push button type operators are disposed in the third side surface region 34, the fourth side surface region 35, and the fifth side surface region 36.

The seventh upper surface region 33 is a display part on which information relating to the sound effect is displayed. An effect display part 37 and a level meter 38 are arranged in the seventh upper surface region 33. The level meter 38 includes a plurality of LEDs 38a. A level adjustment part 39 is disposed in the sixth upper surface region 32. A speaker 40 that generates a sound is disposed in a right rear portion in the third region R3.

The operators 14, 15, 24, and 41 to 45 are rotation type operators. The operators 14, 15, and 24 can be pushed down. When a pushing force is applied, the operators sink, and when the pushing force is released, the operators return to an original state. The operator 46 is a slide type operator. The operators 18, 26, and 27 are push button type operators. When a pushing force is applied, the operators sink, and when the pushing force is released, the operators return to an original state.

The operators arranged in the side surface regions 13, 23, 34, 35, and 36 are not limited to the push button type, and some or all of the operators may be a slide type or a rotation type. An operation method of each of the above-described operators is not limited. In addition, a signal input/output terminal and a power supply terminal are also arranged in any one of the side surface regions, for example, in the fifth side surface region 36.

Further, lamps 16A, 16B, 16C are arranged next to the operator 14. Lamps 17A, 17B, 17C are arranged next to each of the operators 15. Lamps 25A, 25B, and 25C are arranged next to each of the operators 24. These lamps indicate a pattern in a selected state (an edit target or a reproduction target).

Next, a function of each operator will be described.

In a general editing procedure, first, a user selects a musical composition to be edited (hereinafter, referred to as a “project”) by operating an operator in the fifth side surface region 36. A plurality of projects can be stored in the device.

In a state where a project is selected, the user sets a rhythm sound by operating an operator in the first region R1. The user can individually set rhythm sounds for the seven tracks corresponding to the respective operators 15. For example, a type of a rhythm sound (including a drum sound and a percussion sound) to be set is assigned to each operator 15, such as a bass drum being assigned to a certain operator 15 and a snare drum being assigned to another operator 15. The user can select a track to be edited by pushing a desired operator 15.

Three patterns can be set in one track. Among the lamps 17A, 17B, 17C, a lamp corresponding to a pattern in the selected state emits light. The user can select a desired pattern as an edit target by rotating the operator 15. Desired patterns can be used in combination for each track. The number of patterns that can be set in one track may be four or more, and the number of lamps may also be four or more. Alternatively, the lamps may be configured to allow a user to recognize a selected state of a number of patterns larger than the number of lamps, for example, by switching an emission color of the lamp or the like.

The operator 14 is a global button, and the user can cause any one of the lamps 16A, 16B, 16C to emit light by rotating the operator 14. In conjunction with the switching of the light emission of the lamps 16A, 16B, 16C, the light emission of the lamps 17A, 17B, 17C and the lamps 25A, 25B, 25C is also switched, and the pattern in the selected state is also switched. That is, the pattern to be in the selected state can be collectively switched by rotating the operator 14.

As an input method of the operators 18, a step sequencer system is adopted. For example, when timings (sixteenth note) obtained by dividing one measure into sixteen segments are associated with the sixteen operators 18, a rhythm pattern can be set by pushing an operator 18 corresponding to a desired timing. Light is emitted from the light emitting part 19 of the operator 18 set as the sound generation timing. At the time of reproduction such as monitor reproduction, light may be emitted from the light emitting part 19 in a color different from the color indicating the setting state according to the timing of progress.

The operators arranged in the first side surface region 13 have functions such as turning the power on and off, stopping reproduction, adjusting an overall sound volume, muting or soloing a track, deleting a pattern, and switching of a display bar when the number of bars of a track is two or more.

In this way, one or more patterns are set for each track, and a rhythm sound signal is generated at the time of reproduction or output. In addition, by reproducing two or more tracks in parallel (overlapping), a drum pattern including a plurality of rhythm sounds is reproduced and outputted.

Next, the user sets a melody sound by an operation of an operator in the second region R2. A type of tone for the melody to be set is assigned to each of the operators 24, such as a first synthesizer sound being assigned to a certain operator 24 or a second synthesizer sound being assigned to another operator 24. The assignment of the tone can be changed. One of the operators 24 (for example, a lower right operator 24) can be used as a sampler. For example, a sound can be acquired using an external microphone, a built-in microphone, or the speaker 40, and a tone obtained by sampling the acquired sound can be assigned to the lower right operator 24.

The user can set four melody parts corresponding to the respective operators 24. The user can select a melody part to be edited by pushing a desired operator 24. Three patterns can be set for each of the melody parts. Among the lamps 25A, 25B, and 25C, a lamp corresponding to a pattern in the selected state emits light. The user can select a desired pattern as an edit target by rotating the operator 24.

The operator 27 is an operator that designates a note. For example, when the C major scale is set, the pitches C, D, and E are associated with the three operators 27 on the rear side in order from the left, and the pitches F, G, A, and B are associated with the three operators 27 on the front side in order from the left. A live input is adopted for the input of the operators 27. The user can input the melody by designating the pitches in accordance with a reproduction beat, for example. By pushing the operator 26, the melody input by the operators 27 is recorded.

Similarly to the light emitting part 19, light is emitted from the light emitting part 28 of the operator 27 corresponding to a sound generation timing. At the time of reproduction such as monitor reproduction, light may be emitted from the light emitting part 28 in a color different from the color indicating the setting state according to the timing of progress.

The operators arranged in the second side surface region 23 have functions such as increasing and decreasing the number of bars, octave setting, scale setting, route sound setting (key transposition), executing sampling, and the like.

In this way, one or more melody patterns are set, and a melody sound signal is generated at the time of reproduction or output. Further, by reproducing the melody pattern and the rhythm pattern in parallel (overlapping), a musical composition including one or more rhythm sounds and one or more melodies is reproduced.

Next, the user sets, by an operation on the operator in the third region R3, a sound effect to be applied to the synthesized sound signal obtained by synthesizing the rhythm sound signal and the melody sound signal (sound design). The user can edit not only the synthesized sound signal but also an individual track (for example, signals such as a bass drum only and/or a snare only).

The user can select the tone (sound parameter) assigned to the operator 24 from preset tones by rotating the operator 41. The user can change and set a pitch, a VOL (volume), and a PAN by rotating the operators 43, 44, and 45, respectively. Further, by switching the effect setting mode, the user can change and set attack, decay, EQ, and the like by rotating the operators 42 to 45. By sliding the operator 46 to the right or left, the user can designate whether to apply an effect (sound effect) to a single track or to apply an effect to all the tracks. The functions implemented by the operation on the operator 46 are not limited to those exemplified. For example, functions of other operators, such as level adjustment, may be switched by the operation on the operator 46.

The user can select an effect to be applied from an effect list by rotating the operator 42. The selected effect is indicated as a notification on the effect display part 37 by luminous characters. The effect display part 37 includes a character indicating an effect name and a backlight. The character portion transmits light.

The user adjusts a level of the effect to be applied by rubbing the level adjustment part 39 in a front-rear direction. A state of the adjusted level is indicated as a notification by the number of LEDs 38a emitting light in the level meter 38. As the level increases, the number of LEDs 38a emitting light as counted from the front increases. The user can grasp the type of the applied effect by the effect display part 37, and can visually grasp the level of the applied effect by the level meter 38.

Some of the operators arranged in the fourth side surface region 35 have functions such as undo/redo, and erasing (or weakening) the effect. Some of the operators arranged in the third side surface region 34 have functions such as switching of the effect setting mode (for example, the attack or the EQ instead of the pitch, the VOL, and the PAN). Some of the operators arranged in the fifth side surface region 36 have functions such as tempo setting, shuffle rhythm setting, and a project switching.

In this manner, the sound effect to be applied to the synthesized sound signal obtained by synthesizing the rhythm sound signal and the melody sound signal is set, and the musical composition including one or more rhythm sounds and one or more melody is reproduced with an effect. The generation device 100 may provide a mode in which reproduction and output can be performed without applying a sound effect to either or both of the rhythm sound signal and the melody sound signal.

An order of input and setting is not limited to the order of the rhythm sound signal, the melody sound signal, and the sound effect, and the user can input and set the order freely.

Here, the first region R1, the second region R2, and the third region R3 are independent of each other. In other words, from the viewpoint of an arrangement space, the regions R1, R2, and R3 are physically independent of each other. Alternatively, the regions R1, R2, and R3 are separately arranged without overlapping each other. Alternatively, at least one of, or each of, the first region R1, the second region R2, and the third region R3 is formed of an undivided, continuous region. That is, the same arrangement space is not shared by the regions R1, R2, and R3.

In other words, all of operators for setting functions necessary for music composition creation appear on a housing, and the operators are collectively arranged for each function. As described above, the regions R1, R2, and R3 have functions of inputting (setting) a rhythm sound, a melody sound, and an effect, respectively, and the functions of the operators are different for each arrangement region (that is, the operators are divided by function). The function applied to each operator is not switched between rhythm-related, melody-related, and effect-related functions. In other words, the same operator is not shared by a plurality of different functions. Alternatively, all of at least one operator assigned to the same function is arranged in a corresponding one of the first region R1, the second region R2, and the third region R3.

Accordingly, for example, the user can focus only on the first region R1 at the time of creating rhythm sounds, can focus only on the second region R2 at the time of creating melody sounds, and can focus only on the third region R3 at the time of setting sound effects. Therefore, it is easy to intuitively perform an operation for generating a sound.

The regions R1, R2, and R3 are colored in different colors. In this regard as well, since the rhythm-related region, the melody-related region, and the effect-related region are visually distinguished, an intuitive operation is facilitated. At least two of the regions R1, R2, and R3 may be colored in different colors.

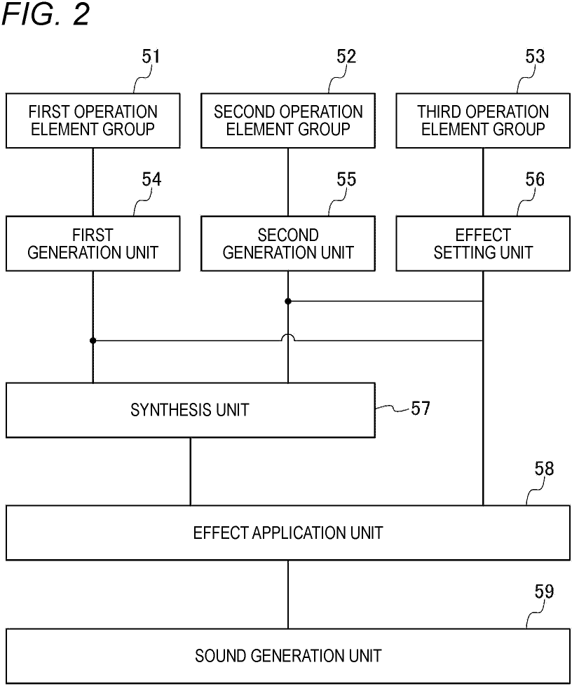

FIG. 2 is a functional block diagram of the generation device 100.

A first operator group 51 includes a plurality of operators arranged in the first region R1. A second operator group 52 includes a plurality of operators arranged in the second region R2. A third operator group 53 includes a plurality of operators arranged in the third region R3. The generation device 100 includes, as functional units, a first generation unit 54, a second generation unit 55, an effect setting unit 56, a synthesis unit 57, an effect application unit 58, and a sound generation unit 59. The functions of these functional units are achieved by cooperation of a CPU, a ROM, a RAM, and the like (not shown). In other words, the generation device may include a memory configured to store instructions, and a processor configured to execute the instructions to cause the generation device 100 to perform functions of at least one of the functional units.

The first generation unit 54 generates a rhythm sound signal based on an operation received by the first operator group 51. The second generation unit 55 generates a melody sound signal based on an operation received by the second operator group 52. The synthesis unit 57 synthesizes the rhythm sound signal generated by the first generation unit 54 and the melody sound signal generated by the second generation unit 55 to generate a synthesized sound signal.

The effect setting unit 56 sets a sound effect to be applied to the synthesized sound signal based on an operation received by the third operator group 53. The effect setting unit 56 can set, based on an operation received by the third operator group 53, the sound effect to be applied individually to the rhythm sound signal and the melody sound signal obtained before the processing by the synthesis unit 57. The effect application unit 58 applies the sound effect set by the effect setting unit 56 to the synthesized sound signal. The sound generation unit 59 includes the speaker 40, and outputs the synthesized sound signal, to which the sound effect is applied by the effect application unit 58, as a sound.

It is not necessarily essential to always apply the sound effect to both the rhythm sound signal and the melody sound signal, and the sound effect may be applied to only one of the signals, or both signals may be output without applying the sound effect. Further, it is not necessarily essential for the rhythm sound signal and the melody sound signal to be always synthesized, and the signals may be independently output. Whether to apply a sound effect and whether to synthesize signals may be set by a user operation.

According to the present embodiment, the generation device 100 includes the first region R1 in which the operators configured to receive an operation for generating a rhythm sound signal are arranged, the second region R2 in which the operators configured to receive an operation for generating a melody sound signal are arranged, and the third region R3 in which the operators configured to receive an operation for applying a sound effect to a synthesized sound signal obtained by synthesizing the rhythm sound signal and the melody sound signal are arranged. The first region R1, the second region R2, and the third region R3 are independent of each other. Therefore, a sound can be generated by an intuitive operation.

In addition, since the regions R1, R2, and R3 are colored in different colors, an intuitive operation is further facilitated.

It is not necessarily essential that the first region R1 and the second region R2 are immediately adjacent to each other, and the second region R2 and the third region R3 are immediately adjacent to each other. There may be another region between the regions R1, R2, and R3. It is not necessarily essential that the regions R1, R2, and R3 are aligned in this order. The regions R1, R2, and R3 may be arranged to define an L-shape as a whole. Alternatively, two of the regions R1, R2, and R3 may be adjacent to the rest one of the regions R1, R2, and R3.

The operators arranged in the first side surface region 13, the second side surface region 23, the third side surface region 34, the fourth side surface region 35, and the fifth side surface region 36 are not limited to a push button type, and may be other types such as a rotation type. The operators arranged in the first region R1 other than the first upper surface region 11 and the second upper surface region 12 are not necessarily arranged in the first side surface region 13, and may be arranged on at least one surface different from the upper surface 105 as far as the operators are arranged in the first region R1. The operators arranged in the second region R2 other than the third upper surface region 21 and the fourth upper surface region 22 are not necessarily arranged in the second side surface region 23, and may be arranged on at least one surface different from the upper surface 105 as far as the operators are arranged in the second region R2. The operators arranged in the third region R3 other than the fifth upper surface region 31 and the sixth upper surface region 32 are not necessarily arranged in the third side surface region 34, the fourth side surface region 35, and the fifth side surface region 36, and may be arranged on at least one surface different from the upper surface 105 as far as the operators are arranged in the third region R3.

All the operators belonging to the regions R1, R2, and R3 may be arranged on the upper surface 105. Alternatively, the operators arranged on the front surface 101, the back surface 102, the left side surface 103, and the right side surface 104 may be excluded from consideration, that is, regions excluding the first side surface region 13, the second side surface region 23, the third side surface region 34, the fourth side surface region 35, and the fifth side surface region 36 may be considered as any one of the first region, the second region, and the third region in the present disclosure. When considered in this way, all of the operators belonging to the first, second, and third regions are on the upper surface 105 which is one of the plurality of operation surfaces, and can be visually recognized and operated from above.

Although the present disclosure has been described in detail based on a preferred embodiment thereof, the present disclosure is not limited to the specific embodiment, and various forms without departing from the scope of the appended claims are also included in the present disclosure.

What is claimed is:

1. A generation device having a plurality of operators that receive a user operation that causes generation of a sound, the generation device comprising:
at least one first operator arranged in a first region of the generation device, the at least one first operator being configured to receive a first user operation that causes generation of a rhythm sound signal;
at least one second operator arranged in a second region of the generation device, the at least one second operator being configured to receive a second user operation that causes generation of a melody sound signal; and
at least one third operator arranged in a third region of the generation device, the at least one third operator being configured to receive a third user operation that causes a sound effect to be applied to a synthesized sound signal, the synthesized sound signal being a synthesized sound signal of the generated rhythm sound signal and the generated melody sound signal,
wherein the first region of the generation device, the second region of the generation device, and the third region of the generation device are different regions of the generation device from each other.

2. The generation device according to claim 1,
wherein the first region of the generation device, the second region of the generation device, and the third region of the generation device are aligned on the generation device in order of the first region, the second region, and the third region.

3. The generation device according to claim 2,
wherein the first region of the generation device and the second region of the generation device are immediately adjacent regions of the generation device to each other.

4. The generation device according to claim 3,
wherein the second region of the generation device and the third region of the generation device are immediately adjacent regions of the generation device to each other.

5. The generation device according to claim 1, further comprising:
a plurality of operation surfaces,
wherein the first region of the generation device, the second region of the generation device, and the third region of the generation device include at least one operation surface of the plurality of operation surfaces.

6. The generation device according to claim 5,
wherein the at least one operation surface is an upper surface of the generation device.

7. The generation device according to claim 1,
wherein the generation device comprises a plurality of operation surfaces, and wherein:
the first region of the generation device extends over a main operation surface of the plurality of operation surfaces and at least one first operation surface of the plurality of operation surfaces, the at least one first operation surface being different from the main operation surface,
the second region of the generation device extends over the main operation surface and at least one second operation surface of the plurality of operation surfaces, the at least one second operation surface being different from the main operation surface,
the third region of the generation device extends over the main operation surface and at least one third operation surface of the plurality of operation surfaces, the at least one third operation surface being different from the main operation surface,
the at least one first operator comprises a plurality of first operators,
the at least one second operator comprises a plurality of second operators,
the at least one third operator comprises a plurality of third operators,
at least one first operator among the plurality of first operators is arranged within the first region on the main operation surface, and at least one first operator among the plurality of first operators is arranged within the first region on the at least one first operation surface different from the main operation surface,
at least one second operator among the plurality of second operators is arranged within the second region on the main operation surface, and at least one second operator among the plurality of second operators is arranged within the second region on the at least one second operation surface different from the main operation surface,
at least one third operator among the plurality of third operators is arranged within the third region on the main operation surface, and at least one third operator among the plurality of third operators is arranged within the third region on the at least one third operation surface different from the main operation surface.

8. The generation device according to claim 1,
wherein the at least one first operator includes a first setting operator configured to receive a fourth user operation that causes a sound generation pattern to be set, and at least one first input operator configured to receive a fifth user operation that causes a sound generation timing to be input.

9. The generation device according to claim 8,
wherein the at least one first input operator includes a plurality of first input operators, and
wherein each of the plurality of first input operators includes a notification part that outputs a notification, the notification indicating information corresponding to a sound generation timing of the generated rhythm sound signal.

10. The generation device according to claim 1,
wherein the at least one second operator includes a second setting operator configured to receive a sixth user operation that causes a musical instrument sound to be set, and a second input operator configured to receive a seventh user operation that causes a pitch to be input.

11. The generation device according to claim 10,
wherein the second input operator is configured to designate a note.

12. The generation device according to claim 1,
wherein the at least one third operator includes a third setting operator configured to receive an eighth user operation that causes a sound parameter to be set, and a fourth setting operator configured to receive a ninth user operation that causes a sound effect to be set.

13. The generation device according to claim 1,
wherein at least two regions among the first region of the generation device, the second region of the generation device, and the third region of the generation device are colored regions, and
wherein the at least two colored regions among the first region, the second region, and the third region are colored in different colors from each other.

14. The generation device according to claim 1,
wherein the third region of the generation device includes a display part on which information on the sound effect is displayed.

15. The generation device according to claim 1, further comprising:
a memory configured to store instructions; and
a processor configured to execute the instructions to cause the generation device to:
synthesize the generated rhythm sound signal and the generated melody sound signal to generate the synthesized sound signal; and
apply, to the synthesized sound signal, the sound effect set by the third user operation of the at least one third operator.
